(19) United States
(12) Patent Application Publication
(10) Pub. No.: US 2014/0361874 A1
(43) Pub. Date: Dec. 11, 2014

(54) TRACKING AND EMERGENCY ALERT DEVICE

(71) Applicant: Amar Mandalapu, Bethlehem, PA (US)

(72) Inventor: Sai Aditya Mandalapu, Bethlehem, PA (US)

(21) Appl. No.: 13/937,212

(22) Filed: Sep. 25, 2013

(30) Foreign Application Priority Data
Jun. 6, 2013 (IN) 2477/CHE2013

(51) Int. Cl. G08B 5/22

(52) U.S. Cl. CPC G08B 5/223
USPC 340/8.1

(57) ABSTRACT

A tracking and emergency alert device is provided which allows a user in emergency to trigger an alert and automatically send it to all the people located in the neighborhood of the user in a community. Each device in the network is identified with a unique identification code. Upon receiving the emergency alert, the end-device carried by the people in the neighborhood, rings an alarm along with vibrations and blinking lights to indicate receipt of an emergency alert so that the user carrying the end-device can approach the location immediately for assistance. The device may also be used to track the movement of the user based on the location coordinate of the nearest wireless access point to which the device is connected at a particular time. Using the device, an emergency alarm can be raised within a second to alert all community around us to ensure security within fraction of seconds.

### PRIORITY CLAIM

This application the benefit under 35 U.S.C. §119 (b) of an application entitled “Tracking and emergency alert device” filed with Indian Patent Office Chennai on Jun. 6, 2013 and assigned an application No. 2477/CHE/2013, the entirety of which is expressly incorporated herein by reference.

### TECHNICAL FIELD OF THE INVENTION

The present invention provides a tracking and emergency alert device which allows a user in emergency to trigger an alert to be sent to all the people located in the neighborhood of the user in a community. The user carrying the device may be tracked at any point of time.

### BACKGROUND OF THE INVENTION

Each day a large number of mishappenings such as kidnapping, abductions and other emergencies occur which include health emergencies or other emergencies that generally happen when an individual involved is alone or is away from his near and dear ones. There is a large and most vulnerable section of society such as children, elderly people and mentally challenged people who suffer from various problems almost in most of the cases. Usually it is observed that during such emergencies, people try to call up ambulance, police or fire brigades etc. to seek their help which may take about 10 minutes to one hour to reach the exact location for assistance. Even though a large number of members in a community such as immediate neighbors, friends or any person walking nearby, are available for immediate help, they are generally left unaware of the events or causality happening in their neighborhood. If such people available nearby can be informed immediately, a large number of causalities may be avoided or prevented.

Many methods and devices have been proposed in the past to provide assistance to people in emergency, but such prior art devices suffer from the main drawback that they all focus on reaching the help through mobile devices or wireless devices which ultimately call the emergency phone numbers or call some pre-defined phone numbers stored in the such devices. Emergency alert devices have been used for quite some time to provide safety and security to people, and especially to the people who are likely to find themselves in a situation wherein they need help, but are unable to reach a telephone to call for help.

Hence a device is needed that can provide emergency alert to the people in their immediate neighborhood who can reach the location within a shorter span of time.

### SUMMARY OF THE INVENTION

The present invention overcomes the problems in the prior art and provides a tracking and emergency alert device which allows a user in emergency to trigger an alert and automatically send it to all the people located in the neighborhood of the user in a community. Each device in the network is identified with a unique identification code. The device is provided with an emergency button which is to be pressed during an emergency to alert the people in the community. Upon pressing the button, the name of the person sending the alert and location of the person is transmitted to all the end devices in the neighborhood.

The end-devices ring an alarm along with vibrations and blinking lights to indicate receipt of an emergency alert so that the user carrying the end-device can approach the location immediately for assistance. The device may also be used to track the movement of the user based on the location coordinate of the nearest wireless access point to which the device is connected at a particular time. The tracking information is continuously sent to a central tracking system. In another embodiment, the invention allows users to exchange unlimited messages from one device to another using wireless Zigbee technology. Using the device, an emergency alarm can be raised within a second to alert all community around us to ensure security within fraction of seconds which otherwise takes approximately 10 min to half an hour time.

The main advantage of device is that it creates a greater sense of security and reduces fear of crime in the mind of general public as they can approach anyone for help in their neighborhood with the press of a button during an emergency.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 shows the tracking and emergency alert device according to an exemplary embodiment of the invention.

FIG. 2 shows block diagram of the system for transmitting emergency alert to people in immediate neighborhood according to various embodiments of the system.

FIG. 3 shows block diagram of the tracking system according to various embodiments of the invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

In the present document, the term ‘display’ means any visual means of communicating the state of the system, e.g., by text and/or symbols and/or numbers. Representative examples of suitable displays include, but are not limited to, LCDs, LEDs, OLEDs, PLEDs, plasma or any other light emitting or modulating mechanism.

The term button or ‘buttons’ means any type of electrical switches, capacitive touch sensors, magnetic sensors, optically activated inputs or any other input mechanism or sensor that may be manipulated by a person.

The term ‘sensor’ or ‘sensors’ means any device capable of sensing a quantity, parameter, condition and/or state.

The term ‘battery’ means any type of well know portable electrical power source, control or storage means.

The term ‘controller’ means processors, such as microprocessors, electronic control devices, state machines and other circuits that may be utilized to electronically control the operation of other circuit elements. In addition, the present controllers may be connected to, or may incorporate therein, memory or storage for storing one or more control programs that are executed by the controller.

The term ‘community’ means a group of people residing within the range of a particular router in a Zigbee network.

A tracking and emergency alert device is provided which allows a user in emergency to trigger an alert and automatically send it to all the people located in the neighborhood of the user in a community. Each device in the network is identified with a unique identification code. Upon receiving the emergency alert, the end-device, carried by the people in the neighborhood, rings an alarm along with vibrations and blinking lights to indicate receipt of an emergency alert so that the user carrying the end-device can approach the location immediately for assistance. The device may also be used to track the movement of the user based on the location coordinate of the nearest wireless access point to which the device is connected at a particular time. Using the device, an emergency alarm can be raised within a second to alert all community around us to ensure security within fraction of seconds.

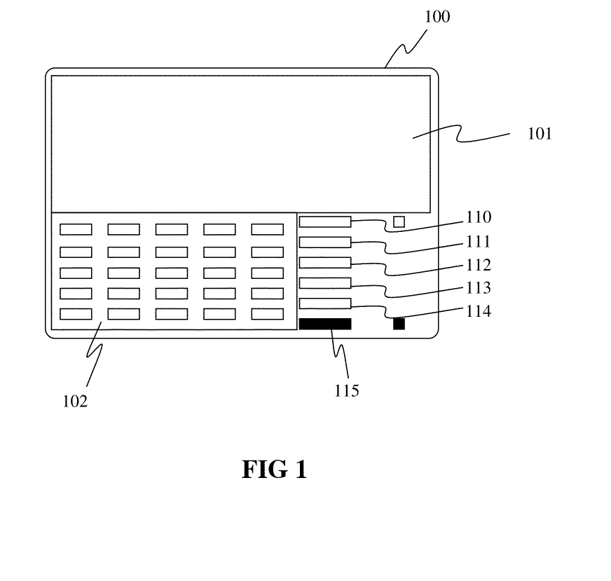

FIG. 1 shows the tracking and emergency alert device according to an exemplary embodiment of the invention. The representative tracking and emergency alert device (100) shown in the figure preferably may include one or more of the following features: a display(101), alphanumeric keyboard (102), plurality of buttons (102), a wireless transceiver, a battery, various switches, connectors, battery level indicator or other optional devices such as one or more sensors. Wireless transceiver is a device capable of transmitting and receiving wireless or radio signals to and from the device. In most preferred embodiment, the device (100) is incorporated in a ZigBee network which creates personal area networks built from small, low-power digital radios. In general, ZigBee enabled devices transmit data over longer distances by passing data through intermediate devices called as wireless access points or routers to reach more distant ones, creating a mesh network; i.e., a network with no centralized control or high-power transmitter/receiver able to reach all of the networked devices.

In most preferred embodiment, the device (100) is provided with a plurality of buttons on the front portion to allow instant access to various functions of the device using a button directly. For example, using the first button (110), the user may configure the device (100) at any point of time. The second button (111) allows the user to enter the test for a normal chat message any time and send it to the intended recipient to initiate a chat session. The third button (112) allows a user to send a predefined message to a similar device of the intended recipient. Upon pressing the fourth button (113), an LED is switched ON for at least 3 seconds confirming the transmittal of the message to the other device. The fifth button (114) may be provided for resetting the device (100) in case of any malfunction or dysfunction of the device(100) due to prolonged usage. Each device in the network may be connected to a central server which stores a record of all the communication between various devices (100) in the network. Upon resetting, the device (100) may request the central server to send the configuration message again so that the device (100) may be reset to the original settings. An emergency button (115) may be provided to transmit an emergency message to the neighboring end-devices. In one embodiment, the emergency button (115) is provided in red color for clear identification of the button during an emergency situation. Upon pressing the emergency button (115) continuously for at least two seconds, the user can send emergency alert to all the neighboring the similar end-devices used by the other users in a community who are within a particular diameter of the user. The emergency alert transmitted to end-devices comprises a message containing name of the user activating the emergency alert, the unique user identification number of the emergency alert device (100) transmitting the data and exact location of the emergency alert device (100).

In one embodiment, the emergency button (115) may be provided in a commonly available mobile phone during manufacturing wherein the button (115) may be configured to the type of alert needed by the user at different times. Type of alert may be a personal alert to a user group pre-selected by the user in the mobile by device of the user or an alert may be sending alert message to the group of users registered in the web application similarly. The alert message is configurable to various types of alerts.

In another embodiment, the device (100) triggers an alarm or buzzer along with vibrations and blinking lights to indicate receipt of an alert from another device. Each emergency alert device (100) and each end-device has a unique identification number for uniquely identifying each device while exchanging the data. While transmitting the emergency alert, the location of the emergency alert device (100) is transmitted to a central server wherein the location of the emergency alert device (100) is derived from the location of the access point to which the emergency alert device (100) is connected at a particular point of time.

In some embodiments, the device (100) may be provided with interfaces for medical electro cardio gram (ECG) (103) that measures the rate and rhythm of the heartbeat. In addition to the above, the device (100) may also have an interface for finger print recognition (104) and authentication of database server with profile validation. In another embodiment, the device (100) is equipped with speed detector (105) which may be used to know the speed of the vehicles approaching from opposite direction and avoid the chances of accidents due to over speeding of other vehicles. Optionally, an output jack (106) may also be provided that displays the distance of the approaching vehicle to alert the user sitting inside of any danger in advance.

The device (100) is designed to continuously or intermittently transmit signal which are preferably received by at least one Zigbee router so that the central control system can accurately derive or determine position or location information of the device (100) to the other people in the community.

The position information derived by the server may be continuously stored in a database on one or more servers. The location/status information may be utilized simply for the purpose of identifying the location of various end device for various other uses, as will be apparent from the present teachings.

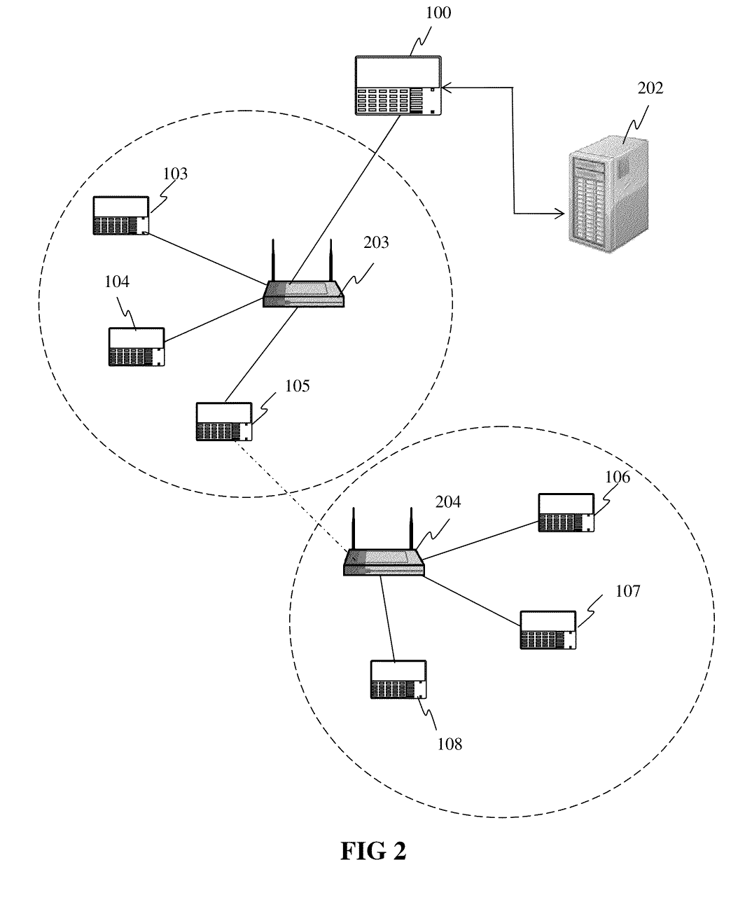

FIG. 2 shows block diagram of the system for transmitting emergency alert to people in immediate neighborhood according to various embodiments of the system. In most preferred embodiment, the system is implemented using ZigBee network which is a specification for a suite of high level communication protocols used to create personal area networks built from small, low-power digital radios. Though low-powered, ZigBee enabled devices often transmit data over longer distances by passing data through intermediate devices to reach more distant ones, creating a mesh network; i.e., a network with no centralized control or high-power transmitter/receiver able to reach all of the networked devices. Zigbee network uses coordinator (in this case, the device (100)), router or wireless access points (e.g. 203, 204) and an end device (e.g. 103, 104, 105, 106, 107, 108) to communicate. In a Zigbee network, coordinators work as a primary device (in this case the device (100)) which acts as a source to commence a networking process. Each device (100) is connected to the nearest access point (203) using nearest path routing algorithm or router notification system. The device (100) transmits information to the access point (203) that acts as a bridge between device (100) and the end device (103, 104, 105) i.e. the recipient of the information. Depending upon the proximity of an end device (103, 104, 105, 106, 107, 108) with the wireless access point (203, 204), there may be any number of end devices in one group called as node. As the need arises, it is possible to form a larger Zigbee network where multiple Zigbee routers or access points are connected to multiple devices and multiple end devices may be connected to each of the multiple Zigbee wireless access points (203, 204). In this scenario, each node of Zigbee network has the option of connecting to multiple end devices hence the ability to form a larger network.

Each device (100) has a memory to store computer-executable instructions. The device (100) has at least two micro controllers communicating with each other using SPI protocol, wherein one micro controller is connected to the Zigbee network using serial communication and the other micro controller is connected to the server (202) which also uses the serial communication. The microcontrollers are communicatively coupled to the memory. The microcontroller facilitates the execution of the computer-executable instructions to perform various operations and also processes the interface with Zigbee network and controls various other interfaces inside the device (100).

A centralized server (202) is used to store the messages interchanged between various devices(100) in the network and also stores configuration settings for the devices. The term ‘server’ means any computing device which is capable of controlling and monitoring the network, receiving signals from various devices (100) and transmitting signals to one or more devices via the wireless access points. The server (202) preferably includes one or more processors or controllers in communication with memory or storage means. The memory or storage means may store one or more control programs for operating and/or administering the server (202) and the network, including some or all components within the network. In addition, the memory or storage means may store various information including but not limited to user profile data, device parameter such as unique identification code of the device or exact location of the device etc. This information can be accessed for use with the device (100) disclosed herein.

Two or more servers (202) may be utilized in combination, as system requirements will determine the specific design and functions that are appropriate for the server (202). The server (202) stores a repository containing user profiles of all the people at a location. The device (100) may be used for communication within a limited diameter in an area wherein the user can communicate with his/her friends or neighbors in a particular locality without any message charges. Depending upon the location of the end device, the message may be transmitted from one community to other community which increases the overall transmission of the message.

The use of ZigBee technology in the device (100) enables long battery life, and enabled short-range wireless transfer of data at relatively low rates. The Zigbee technology allows less expensive transmission of data among various other devices as compared to other technologies such as Bluetooth or Wi-Fi. Since Zigbee networks are secured by 128 bit symmetric encryption keys, there is no fear of loss of data. Zigbee network has a capacity of connecting more than 65,000 devices through different networking topologies. As compared to other wireless technologies, Zigbee network covers a wide range from 10-40 m.

In one embodiment, the device (100) may be used as an emergency alert device wherein an alert message is transmitted to the end device in the area within the communication range of the device (100). Each end-device carried by the people in a community has a unique identification number called as unique identification number. The identification number is used to discriminate between messages from other wireless devices in the network. In operation, the device (100) transmits one or more signals that are received by one or more end devices. The wireless messages or information may be transmitted from one community to another community by using the TCP/IP protocol or by xbee with TCP/IP built-in feature. Since the device (100) is based on Zigbee technology, there are no restrictions on the total number of messages to be transmitted.

The devices (100) are adapted to automatically transmit emergency alert to end-devices in response to activation of emergency alert on the emergency alert device by the user wherein the emergency alert device and end-device are connected to at least one wireless access point in the network.

In operation, each device(100) is provided with an emergency button, whenever a person anticipates a dangerous situation or is in fear, he/she may immediately press the emergency button on the device (100) that transmits an alert message in the form of a text message to all the people carrying the similar Zigbee enabled device (100) and residing closest to the area where user is located. In one embodiment, the text message may include information such as name of the person sending the message, pre assigned unique identification number of the device (100) carried by the user along with the location, date and time of sending the message. The location of the user is determined by wireless access point in closest proximity to the user device (100) at the time of sending the information. Based on the location of the wireless access point, the exact location of the user may be determined and sent as a text message. As soon as the message is sent to the end device (103, 104, 105, 106, 107, 108) carried by the people located closest to the user carrying the device (100), people may approach the exact location of the user for help or assistance immediately. Within a very small span of time, the person in danger may get help from the community without involving any third party service providers such as mobile phone service provides etc. or without spending any money. This is especially useful for the elderly and small children as whenever they find themselves in danger or need help, they may press the emergency button in the device and call for immediate help from the people located nearest to them. This may prevent a large number of mishaps that usually occur due to delay in reaching the crime scene or delay in providing first aid to the victim. The device (100) also alerts other people in community by switching ON the LED bulbs on the device (100) to sway the danger.

The device (100) may be provided with various modes suiting to various situations. In one embodiment, the device (100) may be put into one mode that may be used in a situation wherein the owner is away from the house and wants all the people in the community to be aware of this so that they can keep an eye over the house in his/her absence. Once the device (100) is put into this mode, all the people in the community will get to know that the owner of the house living in a particular house number and having a particular phone number is away from the house. In such a situation, the group community can monitor in his/her absence for any unauthorized entry inside the house. To enable this mode, the device (100) may be equipped with Passive Infra-Red(PIR sensor) to detect the motion of intruders. The device (100) may also equipped with magnetic sensors to detect opening and closing of doors and also vibration sensor attached with windows to detect any break opening through the windows. The IR sensors (infrared sensors) in the device (100) detect the presence of intruders in case any person crosses predefined line/boundaries inside the house. In this embodiment, the phone numbers and email IDs of all the people in the community is stored in the device (100) and the device (100) is provided with a facility to automatically transmit emails to all the email IDs or may be preconfigured to automatically transmit SMS or to dial phone numbers of all the community members upon any unauthorized intrusion.

In one embodiment, another mode may be provided. In this mode, the owner is away from the house and doesn't want anyone in the community to be aware of this except for a few ones such as close friends or relatives etc. In this embodiment, a limited set of predefined phone numbers and email IDs of the people in the community is stored in the device (100) wherein upon any unauthorized intrusion inside the house; a predefined email is automatically transmitted to a predefined email IDs or a phone call is made to the predefined phone number. SMS may also be sent to the predefined phone number of the people in the community.

In another embodiment, one more mode may be provided wherein a predefined phone number and email IDs of the one or more people is stored in the device (100) wherein upon any unauthorized intrusion inside the house, a predefined email is automatically transmitted to a predefined email ID and an SMS may be sent to the predefined phone number. In this embodiment, the email, phone call or SMS is not shared with the community member to preserve privacy of the owner.

In some embodiments, the device (100) may be used by vulnerable section of society such as children, elderly people and mentally challenged people as well. In case of small children, their exact location inside the school or during transportation in the school bus may be easily tracked using the device and system disclosed herein. Elderly people or mentally challenged people can use the device and system to call for help anytime from the people in the community nearby. Using the device, an emergency alarm can be raised within a second to alert all community around us to ensure security within fraction of seconds which otherwise takes approximately 10 min to half an hour time.

Persons skilled in the art will recognize that various other encodings and/or identification schemes may be utilized with present teachings depending upon the particular application of the present teachings.

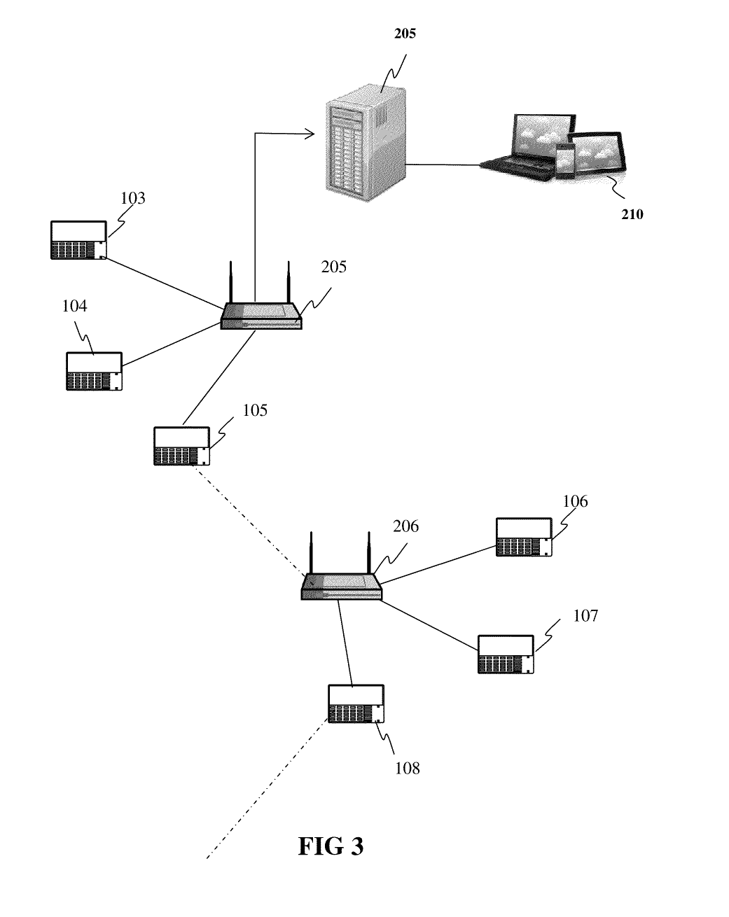

FIG. 3 shows block diagram of the tracking system according to various embodiments of the invention. In this embodiment, the device (103 to 108) according to the embodiments of the present invention may be used as a tracking device for tracking the movement or activities of the users carrying the device. This can be used in companies, buildings, apartments, industries, educational institutions, commercial complexes etc. In this embodiment, each user or employee in a company, a worker in a factory or a child in an educational institution may be provided with the tracking device (103 to 108). Each device (103 to 108) is connected to the nearest wireless access point(203 or 204) using nearest path routing algorithm or router notification system. The devices(103 to 108) continuously transmit data signal to a central server (205) in the network connected central tracking system (210) which keeps track of the location of the user carrying the tracking device (103 to 108) wherein the location is derived from the location of the access point to which the tracking device (103 to 108) is connected at a particular point of time.

Since, the range of each wireless access point is a few meters, every time the person carrying the device (103 to 108) moves from one location to another, the device (103 to 108) automatically establishes connection with a new wireless access point(205 or 206) which is closest to the device (103 to 108). The wireless access point(205 or 206) then transmits data signal to the concerned device (103 to 108) to reconfigure its destination ID and the device (103 to 108) gets disconnected from one wireless access point and connects to the nearest wireless access point depending upon the range of the wireless access point and the distance of the device (103 to 108) from the wireless access point (205 or 206). The processor in the device (103 to 108) processes the data and transmits the unique identification number of the wireless access point located closest to the device (103 to 108) for identifying the location of the tracking device (103 to 108). The data also includes the unique device identification number of the device (103 to 108) wherein each device (103 to 108) has a unique identification number for uniquely identifying each device in the network. This helps to keep track of each user carrying the device (103 to 108) continuously with time limit pre-defined by the administrator. Using the web based application, administrator may view the reports from any location and track all the employee activities such as office ‘in time’ and ‘out time’, the time spent at work station, the time spent in the meeting room, or any visits to the prohibited areas such as server rooms etc. In case the system is used in a factory, the movements of the factory workers may be tracked accurately.

The device (100) provides an inexpensive and efficient system for tracking without using any third party services.

In another embodiment, the tracking and emergency alert device (100) may be used as a social networking device without any modifications wherein users can exchange message with each other.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

I claim:

1. An emergency alert device to alert people in immediate neighborhood, the device comprising:
a) a wireless transceiver;
b) a battery;
c) an emergency alert button to trigger the emergency alert;
d) a display;
e) a controller in communication with the wireless transceiver and battery wherein upon pressing the button, the controller is configured to generate a data signal as emergency alert wherein the data signal comprises:
name of the user activating the emergency alert; and
the unique identification number of the emergency alert device transmitting the data;
exact location of the emergency alert device.
wherein the device transmits emergency alert to plurality of neighboring end-devices in response to activation of emergency alert wherein the emergency alert is indicative of occurrence of an emergency.

2. The emergency alert device as claimed in claim 1 wherein the device is in communication with at least one wireless access point.

3. The emergency alert device as claimed in claim 1 wherein both, the emergency alert device and end-device are connected to at least one access point forwarding the data in a network.

4. The emergency alert device as claimed in claim 1 wherein the location of the emergency alert device is transmitted to a central server wherein the location of the emergency alert device is derived from the location of the access point to which the emergency alert device is connected at a particular point of time.

5. The emergency alert device as claimed in claim 1 wherein each emergency alert device and each end-device has a unique identification number for uniquely identifying each device while exchanging the data.

6. The emergency alert device as claimed in claim 1 wherein upon receiving the emergency alert, the end-device triggers an alarm along with vibrations and blinking lights to indicate receipt of an emergency alert from emergency alert device.

7. The emergency alert device as claimed in claim 1 wherein upon detecting an unauthorized intrusion inside the house the device is configured to automatically transmit at least one of:
a. an email to a predefined email ID;
b. a phone call to a predefined phone number, or
c. an SMS (Short Message Service) to a predefined phone number.

8. The emergency alert device as claimed in claim 1 wherein the emergency alert device is a mobile device capable of sending and receiving cellular data in a wireless network.

9. A system for transmitting emergency alert to people in immediate neighborhood, the system comprising:
a) an emergency alert device comprising a wireless transceiver operated by a battery powered controller wherein the emergency alert device is configured to trigger an emergency alert upon press of a button, the emergency alert comprising:
name of the user activating the emergency alert; and
the unique identification number of the emergency alert device transmitting the data;
exact location of the emergency alert device,
b) at least one end-devices network connected to emergency alert device wherein the end-device comprises a wireless transceiver, a display and a battery;
c) at least one wireless access point in network communication with both, the emergency alert device and the end-device;
d) a central server in network communication with the emergency alert device and end-device wherein the central server stores a record of all the communication between all the emergency alert devices and end-devices wherein the central sever continuously stores updated location information of the emergency alert device,
wherein the emergency alert device is adapted to automatically transmit emergency alert to end-devices in response to activation of emergency alert on the emergency alert device by the user wherein the emergency alert device and end-device are connected to at least one wireless access point in the network.

10. The system as claimed in claim 9 wherein both, the emergency alert device and end-device have unique identification numbers for uniquely identifying each device in the network.

11. The system as claimed in claim 9 wherein upon receiving the emergency alert, the end-device rings an alarm along with vibrations and blinking lights to indicate receipt of an emergency alert from another device so that the user carrying the end-device can approach the location immediately for assistance.

12. The system as claimed in claim 9 wherein while transmitting the location of emergency alert device to the end-devices, the location is derived from the location of the access point to which the emergency alert device is connected at a particular point of time.

13. The system as claimed in claim 9 wherein upon detecting an unauthorized intrusion inside the house the device is configured to automatically transmit at least one of:
a. an email to a predefined email ID;
b. a phone call to a predefined phone number, or
c. an SMS (Short Message Service) to a predefined phone number.

14. The system as claimed in claim 9 wherein the emergency alert device is a mobile device capable of sending and receiving cellular data in a wireless network.

15. A tracking device for tracking the movement of the users, the device comprising:
a. a wireless transceiver;
b. a battery;
c. a controller in communication with the wireless transceiver and battery wherein the controller is configured to generate a data signal comprising:
a unique identification number of the wireless access point to which the device is connected in the wireless network; and
a unique device identification number of the tracking device wherein each tracking device has a unique identification number for uniquely identifying each device in the network,
wherein the tracking device continuously transmits data signal to a central server in a network connected central tracking system wherein the central tracking system keeps track of the location of the user carrying the tracking device wherein the location is derived from the location of the access point to which the tracking device is connected at a particular point of time.

16. The tracking device as claimed in claim 15 wherein the device is in communication with at least one wireless access point.

17. The tracking device as claimed in claim 15 wherein record of all the tracking data about the tracking devices is stored by the server in the central tracking system.

18. A tracking system comprising:
a) a tracking device comprising a wireless transceiver operated by a battery powered controller wherein the tracking device is configured to generate a data signal comprising:
the unique identification number of the wireless access point to which the device is connected in the network; and
unique device identification number of the tracking device wherein each tracking device has a unique identification number for uniquely identifying each device in the network,
b) at least one wireless access point in network communication with both, the tracking device;
a) a central server in network communication with the tracking device wherein the central server continuously stores updated location information of the tracking device wherein the location is derived from the location of the wireless access point to which the tracking device is connected at a particular point of time.

19. The system as claimed in claim 18 wherein each tracking device has a unique identification number for uniquely identifying each device in the network.
